(19) United States
(12) Patent Application Publication
(10) Pub. No.: US 2024/0414729 A1
(43) Pub. Date: Dec. 12, 2024

(54) PAGING MONITORING IN TERMINAL DEVICE

(71) Applicant: Nokia Technologies Oy, Espoo (FI)

(72) Inventors: Timo KOSKELA, Oulu (FI); Jorma Johannes KAIKKONEN, Oulu (FI); Mihai ENESCU, Espoo (FI)

(73) Assignee: Nokia Technologies Oy, Espoo (FI)

(21) Appl. No.: 18/702,515

(22) PCT Filed: Jul. 28, 2022
(86) PCT No.: PCT/EP2022/071154

§ 371 Date: Apr. 18, 2024

(30) Foreign Application Priority Data
Oct. 18, 2021 (FI) 20216073

(51) Int. Cl. H04W 72/231; H04W 68/02; H04W 72/0446

(52) U.S. Cl. CPC H04W 72/231; H04W 68/02; H04W 72/0446

(57) ABSTRACT

This document discloses a solution for using a search space configuration for detecting a paging identifier. According to an aspect, a method in a terminal device comprises: receiving, for a control resource set, a first search space configuration for searching a downlink control channel carrying an identifier of the apparatus, wherein the first search space configuration defines a first time interval between consecutive periodic search windows; receiving, for the control resource set, a second search space configuration for searching for a downlink control channel carrying a paging identifier associated with the apparatus, wherein the second search space configuration defines a second time interval between consecutive periodic search windows; enabling the second search space configuration upon receiving a message indicating a cell having a cell identifier different from a cell identifier of a cell serving the apparatus; and searching for the identifier according to the first search space configuration and, in response to the enabling, searching for the paging identifier according to the second search space configuration.

### FIELD

Various embodiments described herein relate to the field of wireless communications and, particularly, to a terminal device monitoring for paging on a control channel.

### BACKGROUND

In a cellular communication system, a terminal device (user equipment, UE) may be configured with one or multiple monitoring occasions within a time slot duration for monitoring a physical downlink control channel (PDCCH) in order to detect and extract downlink control information (DCI) addressed to the terminal device. The DCI carries, for example, paging information or scheduling information indicating uplink or downlink resources scheduled to the terminal device for data transmission or reception. The terminal device attempts to find the DCI addressed to it amongst a configured control resource set (CORESET). The CORESET may include a configured common search space (CSS) common to multiple terminal devices and/or a terminal-device-specific search space (USS)

Inter-cell beam management means that a terminal device may be configured to communicate with one or more additional cells that are different from a serving cell, e.g. have different physical cell identifiers (PCI). The serving cell may remain as a point of attachment for the terminal device. This operation is called dynamic point selection (DPS) in some literature. The serving cell does not change but the terminal device can be configured and indicated to receive at least some dedicated channels from the one or more additional cells while still maintaining the serving cell (radio resource control) connection.

Paging can be applied together with the inter-cell beam management. In addition to inter-cell beam management, the methods herein can be considered for inter-cell multiple-TRP (multiple transmission-reception points) communication where a terminal device can be configured to communicate with a serving cell and at least one other cell in addition to serving cell. It means that the terminal device would be capable of receiving a paging indication via the serving cell or via the one or more additional cells. The terminal device would then aim to decode its paging radio network temporary identifier (P-RNTI) amongst signals received from the serving cell and from the one or more additional cells. However, current implementations enable the terminal device to carry out paging monitoring only in a CSS for the serving cell and in the USS for the one or more additional cells. The problem of using the USS for the paging is that the USS is typically configured with a shorter periodicity than the CSS. Furthermore, discontinuous reception (DRX) functions of the terminal device ignore the paging, i.e. the DRX is not applied to the paging monitoring. Accordingly, improvements to carry out the paging are needed.

### BRIEF DESCRIPTION

Some aspects of the invention are defined by the independent claims.

Some embodiments of the invention are defined in the dependent claims.

The embodiments and features, if any, described in this specification that do not fall under the scope of the independent claims are to be interpreted as examples useful for understanding various embodiments of the invention. Some aspects of the disclosure are defined by the independent claims.

According to an aspect, there is provided an apparatus comprising means for performing: receiving, for a control resource set, a first search space configuration for searching a downlink control channel carrying an identifier of the apparatus, wherein the first search space configuration defines a first time interval between consecutive periodic search windows; receiving, for the control resource set, a second search space configuration for searching for a downlink control channel carrying a paging identifier associated with the apparatus, wherein the second search space configuration defines a second time interval between consecutive periodic search windows; enabling the second search space configuration upon receiving a message indicating a cell having a cell identifier different from a cell identifier of a cell serving the apparatus; and searching for the identifier according to the first search space configuration and, in response to the enabling, searching for the paging identifier according to the second search space configuration.

In an embodiment, the first search space configuration and the second search space configuration are both terminal-device-specific search space configurations unique to the apparatus.

In an embodiment, at least one of the means is further configured, in a case where the second search configuration has not been configured, to search for the paging identifier from a common search space of a cell serving the apparatus.

In an embodiment, the second time interval is different from the first time interval. In an embodiment, the second time interval is equal to or longer than the first time interval.

In an embodiment, the first search space configuration defines a common search space common to the apparatus and at least one other apparatus, and wherein at least one of the means is further configured to prioritize the second search space configuration over the first search space configuration, if the first and the second search space configurations occur concurrently.

In an embodiment, at least one of the means is further configured to monitor for the paging identifier only according to the second search space configuration.

In an embodiment, the first search space configuration defines a common search space common to the apparatus and at least one other apparatus, and wherein the first time interval is equal to the second time interval.

In an embodiment, at least one of the means is further configured to enable discontinuous reception between consecutive periodic search windows of the second search space configuration.

In an embodiment, the means comprises at least one processor and at least one memory comprising computer program instructions, wherein the at least one processor, the at least one memory, and the computer program instructions cause the above-described performance of the apparatus.

According to an aspect, there is provided an apparatus comprising means for performing: configuring, for a terminal device and for a control resource set, a first search space configuration for searching a downlink control channel carrying an identifier of the terminal device, wherein the first search space configuration defines a first time interval between consecutive periodic search windows; configuring, for the terminal device and for the control resource set, a second search space configuration for searching a downlink control channel carrying a paging identifier of the terminal device, wherein the second search space configuration defines a second time interval between consecutive periodic search windows; and causing transmission of the paging identifier to the terminal device according to the second search space configuration.

In an embodiment, the means are configured to disable the second search space configuration, if the first search space configuration has been configured for paging.

In an embodiment, the means are configured to enable the second search space configuration by transmitting to the terminal device a message indicating a cell having a cell identifier different from a cell identifier of a cell serving the terminal device.

In an embodiment, the means comprises at least one processor and at least one memory comprising computer program instructions, wherein the at least one processor, the at least one memory, and the computer program instructions cause the above-described performance of the apparatus.

According to an aspect, there is provided a method comprising: receiving, by a terminal device for a control resource set, a first search space configuration for searching a downlink control channel carrying an identifier of the apparatus, wherein the first search space configuration defines a first time interval between consecutive periodic search windows; receiving, by the terminal device for the control resource set, a second search space configuration for searching for a downlink control channel carrying a paging identifier associated with the terminal device, wherein the second search space configuration defines a second time interval between consecutive periodic search windows; enabling, by the terminal device, the second search space configuration upon receiving a message indicating a cell having a cell identifier different from a cell identifier of a cell serving the terminal device; and searching, by the terminal device, for the identifier according to the first search space configuration and, in response to the enabling, searching for the paging identifier according to the second search space configuration.

In an embodiment, the first search space configuration and the second search space configuration are both terminal-device-specific search space configurations unique to the terminal device.

In an embodiment, the means are, in a case where the second search configuration has not been configured, to search for the paging identifier from a common search space of a cell serving the terminal device.

The cell serving the terminal device may have a radio resource control connection with the terminal device while the cell having the cell identifier different from the cell identifier of the cell serving the terminal device may have no radio resource control connection with the terminal device at the time of searching for the paging identifier.

In an embodiment, the second time interval is different from the first time interval. In an embodiment, the second time interval is longer than the first time interval.

In an embodiment, the first search space configuration defines a common search space common to the terminal device and at least one other terminal device, and wherein the terminal device prioritizes the second search space configuration over the first search space configuration, if the first and the second search space configurations occur concurrently.

In an embodiment, the terminal device monitors for the paging identifier only according to the second search space configuration.

In an embodiment, the first search space configuration defines a common search space common to the terminal device and at least one other terminal device, and wherein the first time interval is equal to the second time interval.

In an embodiment, the terminal device enables discontinuous reception between consecutive periodic search windows of the second search space configuration.

According to an aspect, there is provided a method comprising: configuring, for a terminal device and for a control resource set, a first search space configuration for searching a downlink control channel carrying an identifier of the terminal device, wherein the first search space configuration defines a first time interval between consecutive periodic search windows; configuring, for the terminal device and for the control resource set, a second search space configuration for searching a downlink control channel carrying a paging identifier of the terminal device, wherein the second search space configuration defines a second time interval between consecutive periodic search windows; and causing transmission of the paging identifier to the terminal device according to the second search space configuration.

In an embodiment, the method is performed by at least one access node of a cellular communication system.

In an embodiment, the at least one access node disables the second search space configuration, if the first search space configuration has been configured for paging.

In an embodiment, the at least one access node enables the second search space configuration by transmitting to the terminal device a message indicating a cell having a cell identifier different from a cell identifier of a cell serving the terminal device.

According to an aspect, there is provided a computer program product embodied on a computer-readable medium and comprising a computer program code readable by a computer, wherein the computer program code configures the computer to carry out a computer process in an apparatus, comprising: receiving, for a control resource set, a first search space configuration for searching a downlink control channel carrying an identifier of the apparatus, wherein the first search space configuration defines a first time interval between consecutive periodic search windows; receiving, for the control resource set, a second search space configuration for searching for a downlink control channel carrying a paging identifier associated with the apparatus, wherein the second search space configuration defines a second time interval between consecutive periodic search windows; enabling the second search space configuration upon receiving a message indicating a cell having a cell identifier different from a cell identifier of a cell serving the apparatus; and searching for the identifier according to the first search space configuration and, in response to the enabling, searching for the paging identifier according to the second search space configuration.

According to an aspect, there is provided a computer program product embodied on a computer-readable medium and comprising a computer program code readable by a computer, wherein the computer program code configures the computer to carry out a computer process comprising: configuring, for a terminal device and for a control resource set, a first search space configuration for searching a downlink control channel carrying an identifier of the terminal device, wherein the first search space configuration defines a first time interval between consecutive periodic search windows; configuring, for the terminal device and for the control resource set, a second search space configuration for searching a downlink control channel carrying a paging identifier of the terminal device, wherein the second search space configuration defines a second time interval between consecutive periodic search windows; and causing transmission of the paging identifier to the terminal device according to the second search space configuration.

### LIST OF DRAWINGS

Embodiments are described below, by way of example only, with reference to the accompanying drawings, in which

FIG. 1 illustrates a wireless communication scenario to which some embodiments of the invention may be applied;

FIGS. 2 and 3 illustrate embodiments of processes for configuring multiple search space configurations;

FIG. 4 illustrates timing of search windows of various search space configurations;

FIG. 5 illustrates a procedure for a terminal device to determine a search space from which to search for a paging identifier according to an embodiment;

FIG. 6 illustrates a procedure for a terminal device to prioritize search spaces according to an embodiment

FIG. 7 illustrates a procedure for implementing discontinuous reception in connection with paging;

FIG. 8 illustrates a signalling diagram according to an embodiment; and

FIGS. 9 and 10 illustrate block diagrams of structures of apparatuses according to some embodiments.

### DESCRIPTION OF EMBODIMENTS

The following embodiments are examples. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may contain also features/structures that have not been specifically mentioned.

In the following, different exemplifying embodiments will be described using, as an example of an access architecture to which the embodiments may be applied, a radio access architecture based on long term evolution advanced (LTE Advanced, LTE-A) or new radio (NR, 5G), without restricting the embodiments to such an architecture, however. A person skilled in the art will realize that the embodiments may also be applied to other kinds of communications networks having suitable means by adjusting parameters and procedures appropriately. Some examples of other options for suitable systems are the universal mobile telecommunications system (UMTS) radio access network (UTRAN or E-UTRAN), long term evolution (LTE, the same as E-UTRA), wireless local area network (WLAN or WiFi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

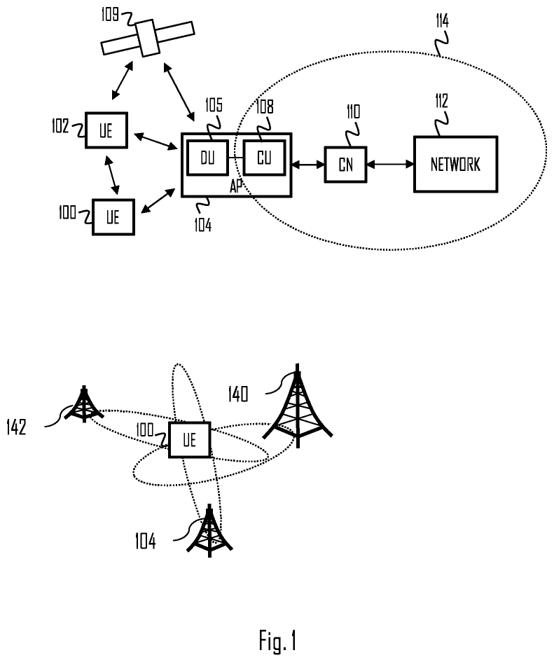

FIG. 1 depicts examples of simplified system architectures only showing some elements and functional entities, all being logical units, whose implementation may differ from what is shown. The connections shown in FIG. 1 are logical connections; the actual physical connections may be different. It is apparent to a person skilled in the art that the system typically comprises also other functions and structures than those shown in FIG. 1.

The embodiments are not, however, restricted to the system given as an example but a person skilled in the art may apply the solution to other communication systems provided with necessary properties.

The example of FIG. 1 shows a part of an exemplifying radio access network.

FIG. 1 shows terminal devices or user devices 100 and 102 configured to be in a wireless connection on one or more communication channels in a cell with an access node (such as (e/g)NodeB) 104 providing the cell. (e/g)NodeB refers to an eNodeB or a gNodeB, as defined in 3GPP specifications. The physical link from a user device to a (e/g)NodeB is called uplink or reverse link and the physical link from the (e/g)NodeB to the user device is called downlink or forward link. It should be appreciated that (e/g)NodeBs or their functionalities may be implemented by using any node, host, server or access point etc. entity suitable for such a usage.

A communications system typically comprises more than one (e/g)NodeB in which case the (e/g)NodeBs may also be configured to communicate with one another over links, wired or wireless, designed for the purpose. These links may be used not only for signalling purposes but also for routing data from one (e/g)NodeB to another. The (e/g)NodeB is a computing device configured to control the radio resources of communication system it is coupled to. The NodeB may also be referred to as a base station, an access point, an access node, or any other type of interfacing device including a relay station capable of operating in a wireless environment. The (e/g)NodeB includes or is coupled to transceivers. From the transceivers of the (e/g)NodeB, a connection is provided to an antenna unit that establishes bi-directional radio links to user devices. The antenna unit may comprise a plurality of antennas or antenna elements. The (e/g)NodeB is further connected to core network 110 (CN or next generation core NGC). Depending on the system, the counterpart on the CN side can be a serving gateway (S-GW, routing and forwarding user data packets), packet data network gateway (P-GW), for providing connectivity of user devices (UEs) to external packet data networks, or mobile management entity (MME), etc.

The user device (also called UE, user equipment, user terminal, terminal device, etc.) illustrates one type of an apparatus to which resources on the air interface are allocated and assigned, and thus any feature described herein with a user device may be implemented with a corresponding apparatus, such as a relay node. An example of such a relay node is a layer 3 relay (self-backhauling relay) towards the base station. 5G specifications define two relay modes: out-of-band relay where same or different carriers may be defined for an access link and a backhaul link; and in-band-relay where the same carrier frequency or radio resources are used for both access and backhaul links. In-band relay may be seen as a baseline relay scenario. A relay node is called an integrated access and backhaul (IAB) node. It has also inbuilt support for multiple relay hops. IAB operation assumes a so-called split architecture having CU and a number of DUs. An IAB node contains two separate functionalities: DU (Distributed Unit) part of the IAB node facilitates the gNB (access node) functionalities in a relay cell, i.e. it serves as the access link; and a mobile termination (MT) part of the IAB node that facilitates the backhaul connection. A Donor node (DU part) communicates with the MT part of the IAB node, and it has a wired connection to the CU which again has a connection to the core network. In the multihop scenario, MT part (a child IAB node) communicates with a DU part of the parent IAB node.

The user device typically refers to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a user device may also be a nearly exclusive uplink only device, of which an example is a camera or video camera loading images or video clips to a network. A user device may also be a device having capability to operate in Internet of Things (IoT) network which is a scenario in which objects are provided with the ability to transfer data over a network without requiring human-to-human or human-to-computer interaction. The user device may also utilize cloud. In some applications, a user device may comprise a small portable device with radio parts (such as a watch, earphones or eyeglasses) and the computation is carried out in the cloud. The user device (or in some embodiments a layer 3 relay node) is configured to perform one or more of user equipment functionalities. The user device may also be called a subscriber unit, mobile station, remote terminal, access terminal, user terminal or user equipment (UE) just to mention but a few names or apparatuses.

Various techniques described herein may also be applied to a cyber-physical system (CPS) (a system of collaborating computational elements controlling physical entities). CPS may enable the implementation and exploitation of massive amounts of interconnected ICT devices (sensors, actuators, processors microcontrollers, etc.) embedded in physical objects at different locations. Mobile cyber physical systems, in which the physical system in question has inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented.

5G enables using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications supports a wide range of use cases and related applications including video streaming, augmented reality, different ways of data sharing and various forms of machine type applications (such as (massive) machine-type communications (mMTC)), including vehicular safety, different sensors and real-time control. 5G is expected to have multiple radio interfaces, namely below 6 GHz, cmWave and mmWave, and also being capable of being integrated with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 6 GHz-cmWave, below 6 GHz-cmWave-mmWave-sub-THz). One of the concepts considered to be used in 5G networks is network slicing in which multiple independent and dedicated virtual sub-networks (network instances) may be created within the same infrastructure to run services that have different requirements on latency, reliability, throughput and mobility.

The current architecture in LTE networks is fully distributed in the radio and typically fully centralized in the core network. The low-latency applications and services in 5G require to bring the content close to the radio which leads to local break out and multi-access edge computing (MEC). 5G enables analytics and knowledge generation to occur at the source of the data. This approach requires leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system is also able to communicate with other networks 112, such as a public switched telephone network or the Internet, or utilize services provided by them. The communication network may also be able to support the usage of cloud services, for example at least part of core network operations may be carried out as a cloud service (this is depicted in FIG. 1 by “cloud” 114). The communication system may also comprise a central control entity, or a like, providing facilities for networks of different operators to cooperate for example in spectrum sharing.

Edge cloud may be brought into radio access network (RAN) by utilizing network function virtualization (NFV) and software defined networking (SDN). Using edge cloud may mean access node operations to be carried out, at least partly, in a server, host or node operationally coupled to a remote radio head or base station comprising radio parts. It is also possible that node operations will be distributed among a plurality of servers, nodes or hosts. Application of cloudRAN architecture enables RAN real time functions being carried out at the RAN side (in a distributed unit, DU 105) and non-real time functions being carried out in a centralized manner (in a centralized unit, CU 108).

It should also be understood that the distribution of functions between core network operations and base station operations may differ from that of the LTE or even be non-existent. Some other technology advancements probably to be used are Big Data and all-IP, which may change the way networks are being constructed and managed. 5G (or new radio, NR) networks are being designed to support multiple hierarchies, where MEC servers can be placed between the core and the base station or node B (gNB). It should be appreciated that MEC can be applied in 4G networks as well.

5G may also utilize satellite communication to enhance or complement the coverage of 5G service, for example by providing backhauling. Possible use cases are providing service continuity for machine-to-machine (M2M) or Internet of Things (IoT) devices or for passengers on board of vehicles, or ensuring service availability for critical communications, and future railway, maritime, and/or aeronautical communications. Satellite communication may utilize geostationary earth orbit (GEO) satellite systems, but also low earth orbit (LEO) satellite systems, in particular mega-constellations (systems in which hundreds of (nano)satellites are deployed). Each satellite 109 in the mega-constellation may cover several satellite-enabled network entities that create on-ground cells. The on-ground cells may be created through an on-ground relay node or by a gNB located on-ground or in a satellite.

It is obvious for a person skilled in the art that the depicted system is only an example of a part of a radio access system and in practice, the system may comprise a plurality of (e/g)NodeBs, the user device may have an access to a plurality of radio cells and the system may comprise also other apparatuses, such as physical layer relay nodes or other network elements, etc. At least one of the (e/g)NodeBs or may be a Home(e/g)nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometers, or smaller cells such as micro-, femto- or picocells. The (e/g)NodeBs of FIG. 1 may provide any kind of these cells. A cellular radio system may be implemented as a multilayer network including several kinds of cells. Typically, in multilayer networks, one access node provides one kind of a cell or cells, and thus a plurality of (e/g)NodeBs are required to provide such a network structure.

Some specifications for cellular communication systems specify a control resource set (CORESET) that is formed by a set of time-frequency resources in the form of a defined number of physical resource blocks (frequency resources) and a defined number of time-domain symbols, e.g. orthogonal frequency-division multiplexing (OFDM) symbols. A CORESET is a repeating time-frequency resource that may or may not carry the DCI on the PDCCH for the terminal device. Furthermore, the PDCCH may be formed by a varying number of control channel elements the terminal device needs to aggregate to detect the PDCCH. A search space (SS) defines an area within a CORESET that is defined as a group of said control channel elements. A search space defines also the periodic time instances when the corresponding CORESET is monitored. A serving access node (eNB or gNB) transmitting the DCI may configure a plurality of CORESETs and said search spaces to the terminal device. The terminal device then performs blind decoding throughout the search spaces. Each search space may be a function of time resources, frequency resources, and the aggregation levels, for example. A higher aggregation level has a greater coverage because of the higher number of control channel elements, allowing for more redundancy in the transmission.

With respect to the PDCCH detection, the number of downlink control channel candidates the terminal device needs to scan for the PDCCH and the downlink control information addressed to the terminal device is a function of several parameters: the number of time-frequency resource units to be scanned, the number of aggregation levels, a duration available for the scanning, etc. Furthermore, the 5G New Radio specifications enable configuring multiple parallel search space configurations to a terminal device. The downlink control channel candidates of comprised in a search space configuration may form a search space set the terminal device is configured to monitor for the downlink control information. The search space set may be defined as a set of PDCCH candidates for the terminal device to monitor. The CORESET is defined in terms of PDCCH search space sets (SS-sets). The search space set may include a common search space set (CSS) defining downlink control channel candidates that are monitored by multiple terminal devices. The search space set may include a terminal-device-specific search space set (USS) defining downlink control channel candidates monitored only by the terminal device. Different radio network temporary identifiers (RNTIs) may be used for the different SS-sets, depending on the type and purpose of the SS-set.

Embodiments described below relate to the paging monitoring scenario discussed in Background. As described above, in a multi-cell scenario where the terminal device receives and processes beams (control signals) from multiple cells, the use of the conventional UE-specific (terminal-device-specific) search space configuration causes high power consumption in the terminal device and may in other ways to be cumbersome. FIG. 1 describes such a multi-cell scenario where the terminal device 100 is within a coverage area of multiple cells managed by respective access nodes 104, 140, 142. Accordingly, cooperative multi-point transmission may be employed to deliver control information to the terminal device via any one of the cells. Let us assume that the access node 104 is serving the terminal device, e.g. via a radio resource control (RRC) connection, and the access nodes 140, 142 are not serving the terminal device and, thus, provide non-serving cells for the terminal device. A non-serving cell may be defined as a cell that may communicate with the terminal device but has no (additional) RRC connection (e.g. additional that is provided by the serving cell RRC entity i.e. the RRC signalling may be provided via serving or non-serving cell via same RRC entity) with the terminal device. In other words, the RRC entity of the serving cell 104 may deliver control messages to the terminal device directly over a radio interface or indirectly via a non-serving cell 140, 142. Accordingly, any one of the access nodes 104, 140, 142 may be used to deliver a paging message to the terminal device. For the purpose of discovering its paging identifier (e.g. a paging radio network temporary identifier, P-RNTI), the terminal device may be configured with one or more search space configurations within a control resource set (CORESET). As described above, the search space configurations may include a common search space (CSS) for the serving cell and a UE-specific search space (USS) per non-serving cell. A cell transmitting a particular identifier, e.g. the P-RNTI, may be indicated via a separate medium access control (MAC) control command that carries a transmission configuration indication (TCI) state indicating a reference signal of the transmitting cell, as known in the art. A list of TCI states may be configured via radio resource control (RRC) signalling, and a TCI state may be enabled via lower layer (e.g., MAC/DCI) signalling. The enabled TCI state(s) enable the terminal device to determine which search spaces to search for its identifier, e.g. to focus the search on certain symbols and frequency resources in a radio signal received from a radio channel.

The paging identifier may be a common identifier that is common to multiple terminal devices. Therefore, it is not dedicated to any single terminal device.

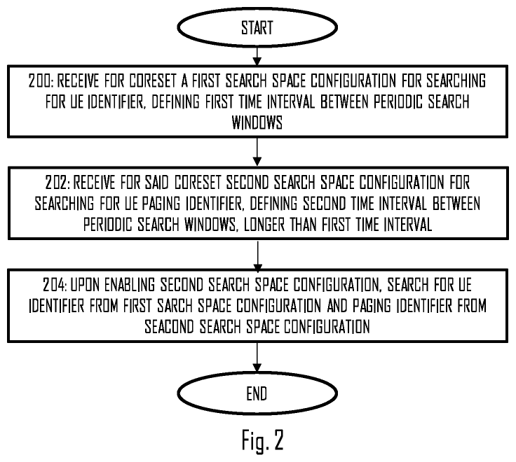

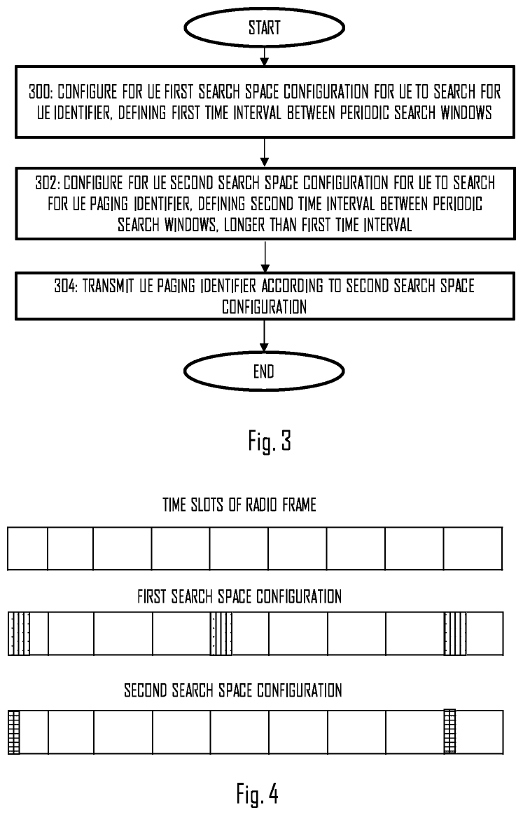

FIGS. 2 and 3 illustrates an embodiment that addresses this problem. FIG. 2 illustrates a procedure for the terminal device, while FIG. 3 illustrates a procedure for an access node or a set of access nodes 104 and 140 or 142. The set of access nodes may control the cell serving the terminal device with the RRC connection and one or more cells not serving the terminal device (called a non-serving cell) with a RRC connection.

Referring to FIG. 2, the procedure in the terminal device comprises: receiving (block 200), for a control resource set (e.g., CORESET described above), a first search space configuration for searching a downlink control channel carrying an identifier of the apparatus, wherein the first search space configuration defines a first time interval between consecutive periodic search windows; receiving (block 202), for the control resource set, a second search space configuration for searching for a downlink control channel carrying a paging identifier associated with the apparatus, wherein the second search space configuration defines a second time interval between consecutive periodic search windows; enabling the second search space configuration upon receiving a message indicating a (first) cell having a cell identifier different from a cell identifier of a (second) cell serving the apparatus; and searching (block 204) for the identifier of the terminal device according to the first search space configuration and, in response to the enabling, searching for the paging identifier according to the second search space configuration.

Referring to FIG. 3, the process comprises in the non-serving access node: configuring (block 300), for a control resource set (CORESET) for the terminal device, a first search space configuration for searching a downlink control channel carrying a identifier of the terminal device, wherein the first search space configuration defines a first time interval between consecutive periodic search windows; configuring (block 302), for the terminal device and for the control resource set, a second search space configuration for searching a downlink control channel carrying a paging identifier associated with the terminal device, wherein the second search space configuration defines a second time interval between consecutive periodic search windows; and causing (block 304) transmission of the paging identifier to the terminal device according to the second search space configuration.

As known in the art, the search for the identifier is subjected to a signal received from a radio channel in time-frequency resources of the configured CORESET. In case the terminal device does detect the respective identifier in the search according to the first and/or second search space configuration, the received signal can be considered to be noise from the perspective of the terminal device. Upon detecting its identifier, the received signal is determined to comprise the identifier, and the terminal device may trigger respective functions, e.g. response to the paging.

In an embodiment, the identifier described in connection with the first search space configuration may be an identifier other than the paging identifier. However, in another embodiment both first and second search space configurations may be associated with the paging identifier. For example, the first search space configuration may define a CSS for the serving cell, while the second search space configuration may define USS for a non-serving cell. In another example, the first search space configuration may define an USS for a CORESET (that may be used for serving cell or for a non-serving cell communication), and the second search space configuration may define an USS configuration for a CORESET used for paging reception in a serving cell or a non-serving cell.

As described above, the UE-specific search spaces (USSs) may be configured to the terminal device for monitoring for an identifier of the terminal device from a beam of a non-serving cell. The non-serving cell may be defined as a cell having a cell identifier (PCI) different from a cell identifier of the serving cell, the non-serving cell still configured for inter-cell beam management/multiple TRP communication for the terminal device. However, thanks to the second or time interval configuration (e.g. where the second time interval may be different from the first time interval), flexibility to the monitoring can be achieved in the terminal device.

In an embodiment, the second time interval is longer than the first time interval. Accordingly, power savings can be achieved for the terminal device.

FIG. 4 illustrates time slots of radio frames and how the CORESET may be arranged within a time slot. A CORESET typically occupies some (orthogonal frequency division multiplexing, OFDM) symbols of the time slot, and the CORESET may have a configured periodicity. As described above, the various search spaces may be configured within the CORESET. In FIG. 4, the first search space configuration is illustrated as occupying a certain number of symbols (four) and having a periodicity of four time slots. It means that the first time interval is four time slots in this example (e.g., three time slots with no first search space between the consecutive time slots having this search space). The second search space configuration below the first search space configuration has a different periodicity, i.e. the second time interval is different from the first time interval and may be longer in this example.

In an embodiment, the first search space configuration and the second search space configuration may be configured as UE-specific search space configurations unique to the apparatus. The first search space configuration may be for monitoring one or more identifiers other than the paging identifier from a search space associated with the non-serving cell. Examples of such identifiers include a cellular radio network temporary identifier (C-RNTI), a cancellation indication RNTI (CI-RNTI), transmit power control RNTI (TPC-RNTI), and availability indication RNTI (AI-RNTI) of the terminal device.

In any of the embodiments herein a cell that is not the serving cell but is used (is active or configured for activation) for inter-cell beam management or inter-cell multi-point transmission (mTRP) may be referred as a non-serving cell or a cell having a cell identifier (PCI) different from the cell identifier of the serving cell. In some cases, the non-serving cell may be referred as assisting cell, additional cell (to serving cell) or the like.

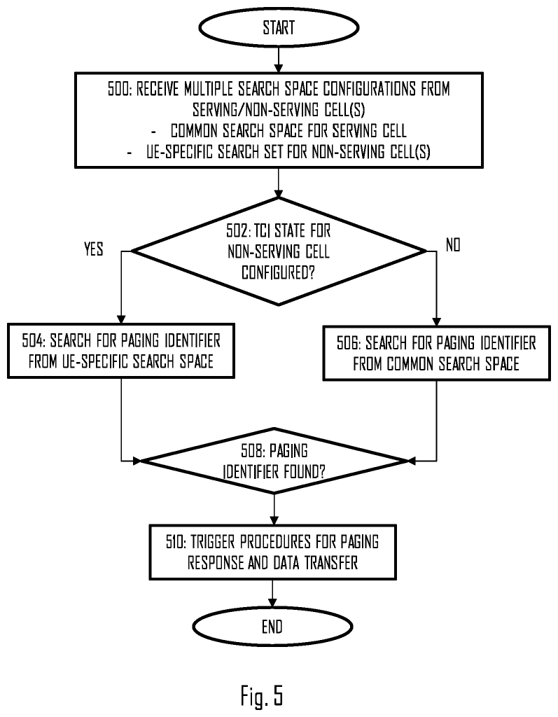

In another embodiment, the first search space configuration may be a CSS configured for a CORESET of a serving cell. The terminal device may have further search space configurations, e.g. the USS configurations for one or more CORESET. In an example, a CORESET may be configured explicitly for a non-serving cell (cell having different PCI than serving cell) CORESET, or the CORESET may be associated with a specific cell through a reference-signal- (RS-) indicated active TCI state for (at least) PDCCH reception. The RS indicated by the active/indicated TCI state for a CORESET may be associated with a specific PCI. USS and CSS search spaces may be configured on the same CORESET. In an embodiment, where the second search space configuration has not been configured (for a CORESET), the terminal device searches for the paging identifier from a common search space of the serving cell. In particular, if a currently active TCI state (e.g. for PDCCH monitoring) or TCI state is not associated with a CORESET (or any of the CORESETs) configured with the second search space configuration, the terminal device may assume that the second search space configuration is not valid for the paging identifier monitoring and, thus, falls back to monitor for the paging identifier within the CSS of the serving cell, e.g. the first search space configuration or a further search space configuration configured for the terminal device via the RRC signalling. FIG. 5 illustrates this embodiment.

Referring to FIG. 5, an RRC layer may configure the multiple search space configurations including the CSS for the serving cell and the USS(s) for one or more non-serving cells in block 500. Then, a TCI state activation (signalled from the serving/non-serving cell/network) may be used to enable one or more of the search space configurations. In block 502, the terminal device determines whether or not the currently active TCI state(s) indicates an RS for a CORESET that is associated with the second search space configuration. In case the active TCI state(s) indicate a non-serving cell (cell with a different PCI that a serving cell), e.g. a reference signal of a non-serving cell, the terminal device may determine that the second search space configuration has been configured for the paging and, as a consequence, attempts to detect its paging identifier within the USS of the non-serving cell in block 504 (e.g. according to the second search space configuration). On the other hand, if the active TCI state(s) for a CORESET(s) with the second search space configuration does not indicate an RS associated with the non-serving cell associated, the terminal device may determine that the second search space configuration has not been enabled and, therefore, searches for the paging identifier from the CSS of the serving cell in block 506. Upon detecting the paging identifier of the terminal device in block 504 or 506 (block 508), the terminal device may trigger a procedure for transmitting a paging response and to proceed to data transfer responsive to the paging in block 510, as known in the art.

In the embodiment of FIG. 5, the terminal device may enjoy the benefit of long periodicity for paging in both blocks 504 and 506, provided that both the USS and the CSS have a longer period than the first search space (USS) configuration the terminal device uses for at least some of the other identifiers.

In any of the embodiments herein, the second search space configuration for a CORESET may refer to an additional search space configuration (e.g. USS) for a CORESET or to a configuration where a configured search space configuration has at least one alternative/additional/modified parameter that is conditionally used. As an example, such parameter(s) may be one or more of monitoringSlotPeriodicityAndOffset, duration, monitoringSymbolsWithinSlot or nrofCandidates.

In any of the embodiment herein, the second search space configuration may be specific for paging monitoring in a cell that has a different PCI than the PCI of the serving cell.

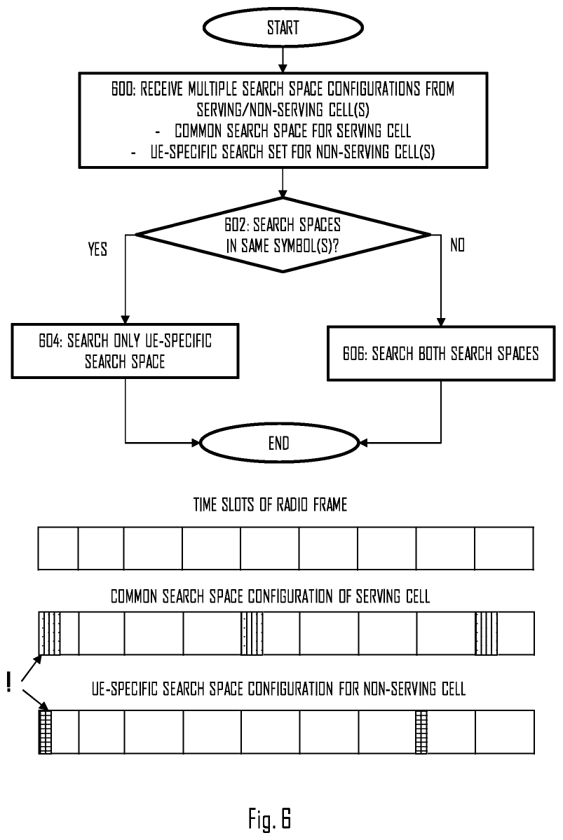

As described above, the terminal device may be configured with the CSS configuration and the second (USS) search space configuration, and both may be enabled concurrently in a CORESET(s) with the active TCI states. As a consequence, the two search space configurations may overlap in time, e.g. they may occur in the same one or more (OFDM) symbols. In such a case, the terminal device may prioritize the second search space configuration over the CSS configuration. In one example, the USS may be prioritized over CSS when the USS is monitored for paging reception (e.g. P-RNTI). FIG. 6 illustrates such an embodiment. Referring to FIG. 6, block 600 may be similar to block 500 in the sense that multiple search space configurations may be configured, the second search space configuration and a CSS configuration. As illustrated on the bottom of FIG. 6, the different search space configurations may have different periodicities and overlap at least in some time slots. When both search space configurations (USS for paging and the CSS) have been enabled and the terminal device detects in block 602 that the two search spaces occur on the same symbol(s), the terminal device may prioritize the USS for the paging and proceed to block 604. In block 604, the terminal device searches the USS first for the paging identifier and omits the search the CSS (for the paging identifier or another identifier of the terminal device). In another embodiment, the terminal device may proceed to search the CSS after completing the search of the USS, if the terminal device still has time and/or resources to search the CSS. On the other hand, if there is no overlap (NO in block 602), the terminal device has no overlapping issue and may search both search space without a need for the prioritization.

In case the second search space configuration (USS) for the paging has not been configured, the terminal device may search the CSS of the serving cell for the paging identifier.

In an embodiment, additionally or alternatively, parameters other than the periodicity may be different for the first and the second search space configurations. Examples of such parameters include the number of frequency resources and/or a number of symbols within a slot, duration (i.e. consecutive slots that a search space lasts in every occasion i.e. upon every period of the search space) included in the respective search space configurations. The second search space configuration may also refer to at least one alternative parameter configured for first search space configuration that is conditionally used for paging monitoring. When the second search space is used for paging monitoring the first search space may be monitored as per configuration.

In an embodiment, the second search space configuration has been configured via the RRC signalling but is not enabled by the active TCI state(s) (e.g. an active TCI state has not been indicated for the CORESET configured with the second search space configuration). In such a case, the terminal device may search the CSS of the serving cell for the paging identifier.

In an embodiment, if the CORESET has been configured with a CSS-type of search space for the paging, it cannot be indicated with an active TCI state(s) where the RS is associated with a PCI different from a serving cell. In another example, an access node of a non-serving cell may disable the second search space configuration (if configured), if the first search space configuration has been configured for paging.

In an embodiment, the same CORESET may be have both a CSS configuration and a USS configuration, and the terminal device monitors for the paging identifier in the CSS or USS which is subject to the active TCI states. For example, if the CORESET has a configured CSS configuration (e.g. where the UE monitors paging in the serving cell) and a configured USS configuration and the active TCI state for a CORESET indicates a RS associated with a cell with PCI different from a serving cell (e.g. a non-serving cell), the terminal device may interpret that the USS configuration (according to a paging search space configuration or according to the second search space configuration) shall be used for paging and searches the USS for the paging identifier. If the CORESET has an active TCI state indicating RS of the serving cell, terminal device assumes the paging monitoring on the CSS. Accordingly, the signalled active TCI states control which one of the search spaces shall be applied for the paging monitoring.

In an embodiment, if the CORESET has a configured CSS configuration with a specific periodicity (e.g. for the paging) and a configured USS configuration(e.g. possibly with no specified periodicity for paging reception), and the set of active TCI states indicates a non-serving cell, the terminal device may interpret that the USS configuration shall be used for the paging but with the specific periodicity of the CSS configuration. In one example, the paging monitoring parameters for the USS is derived based on the parameters (e.g. search space related parameters) for paging reception of at least on CSS. In another example, the paging monitoring on a cell with different PCI than serving cell is performed on a USS. Accordingly, the potentially longer period of the CSS configuration (or at least one parameter of the CSS configuration) may be inherited to the USS configuration for the purpose of paging. The terminal device may at the same time search the USS search space for another identifier with a different periodicity.

In any of embodiments, the paging monitoring on a cell (e.g. on a USS) with different PCI may refer to the monitoring of the specific DCI format carrying a Short Message. As an example, the Short Message carried by the DCI may indicate system information modification (e.g. systemInfoModification) and it may cause the terminal device to monitor the (modified) system information on the serving cell.

In any of the embodiment, the P-RNTI used for paging monitoring in USS may be specific to a cell (e.g. specific to a PCI) where the paging is monitored. Alternatively, the P-RNTI for paging monitoring on USS (on a cell with different PCI than serving cell) may be the same as the serving cell P-RNTI.

In one embodiment, when UE assumes the second search space configuration (for P-RNTI monitoring) according to the embodiments, the second search space configuration is used for only P-RNTI monitoring.

In one embodiment, UE capable of monitoring both serving cell CSS and USS of a cell with different PCI than serving cell (e.g. for paging) may select which search space is used for monitoring. This selection may be performed when at least one symbol of the monitoring of an RNTI (e.g. P-RNTI) on the CORESETs (e.g. the USS and CSS for paging monitoring may in same or different CORESETs) overlap

The second time interval for the second search space configuration for paging may be configured the following manner. The following modification to SearchSpace information element of the standard for the 5G New Radio may be made. As a new element, monitoringSlotPeriodicityAndOffsetPAGING may be implemented.

### SearchSpace Information Element

-- ASN1START
-- TAG-SEARCHSPACE-START

| | |
|---|---|
| SearchSpace ::= | SEQUENCE { |
| searchSpaceId | SearchSpaceId, |
| controlResourceSetId ControlResourceSetId | OPTIONAL, -- Cond |

SetupOnly

| | |
|---|---|
| monitoringSlotPeriodicityAndOffset | CHOICE { |

... }
OPTIONAL, -- Cond ue-Specific

| | |
|---|---|
| monitoringSlotPeriodicityAndOffsetPAGING | CHOICE { |
| sl1 | NULL, |
| sl2 | INTEGER (0..1), |
| sl4 | INTEGER (0..3), |
| sl5 | INTEGER (0..4), |
| sl8 | INTEGER (0..7), |
| sl10 | INTEGER (0..9), |
| sl16 | INTEGER (0..15), |
| sl20 | INTEGER (0..19), |
| sl40 | INTEGER (0..39), |
| sl80 | INTEGER (0..79), |
| sl160 | INTEGER (0..159), |
| sl320 | INTEGER (0..319), |
| sl640 | INTEGER (0..639), |
| sl1280 | INTEGER (0..1279), |
| sl2560 | INTEGER (0..2559) |

}
...

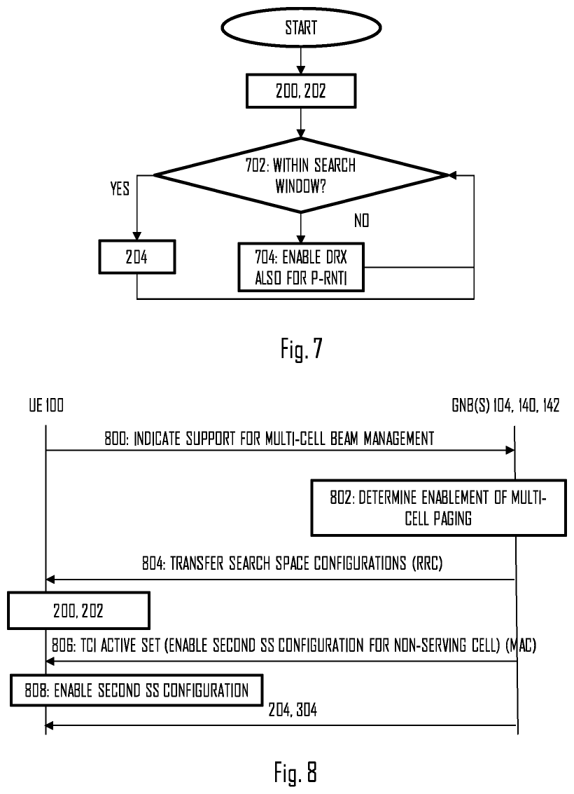

Conventionally, the discontinuous reception (DRX) has not been applied in connection with paging. In particular with the longer second time interval, the DRX may enable further power savings. Accordingly, the terminal device may enable the DRX between consecutive periodic search windows of the second search space configuration, when the second search space configuration has been enabled and is used by the terminal device. FIG. 7 illustrates such an embodiment. Referring to Figure, upon carrying out blocks 200 and 202 (the RRC signalling related to the search space configurations), the terminal device may conduct the search for its paging identifier according to the second search space configuration that has been enabled. In block 702, the terminal device determines whether or not it is within a search window of the second search space configuration. If the terminal device is within the search window, it may carry out the search for the paging identifier according to the second search space configuration in block 204. If the terminal device is not within the search window and has no active search for the paging identifier going on, it may enter a DRX mode in block 704 and disable at least some receiver functions, thus reducing power consumption. Accordingly, the DRX mode is enabled also for the paging identifier (P-RNTI). The terminal device may be in an RRC CONNECTED mode with respect to the serving cell (and for the cell with different PCI than serving cell) while performing the process of FIG. 7.

A MAC entity of the terminal device may thus be configured by RRC signalling with a DRX functionality that controls the terminal device's PDCCH monitoring activity for the MAC entity's P-RNTI when a TCI state indicating a reference signal for a PCI (physical cell identifier) other than the serving cell has been activated (and indicated) for at least one CORESET. From another perspective, the MAC entity may be configured by the RRC signalling with a DRX functionality that controls the terminal device's PDCCH monitoring activity for the MAC entity's P-RNTI when a TCI state for a PCI different from the serving cell has been activated (and indicated) for a CORESET. When using the DRX operation, the MAC entity may also monitor PDCCH according to requirements found in other clauses of this specification. When in the RRC CONNECTED mode, if the DRX is configured for all the activated serving cells, the MAC entity may monitor the PDCCH discontinuously using the DRX operation. In other words, the MAC entity of a terminal device considers the P-RNTI monitoring according to the configured DRX cycle i.e. MAC is not required to monitor P-RNTI when it is not on active time. Alternatively, or additionally, the physical layer may not monitor DCI format associated with P-RNTI or paging when UE is not on active time, when the paging is monitored on USS (e.g. when the USS monitoring is on a CORESET with an active TCI state indicating RS that is associated with a cell with different PCI than serving cell)

FIG. 8 illustrates a signalling diagram combining the procedures of FIGS. 2 and 3. Referring to FIG. 8, the terminal device may indicate its capability for multi-cell beam management in step 800. This may be a part of RRC connection setup or reconfiguration with the serving cell, for example. The serving access node may then determine a set of cell(s) for use in the multi-cell beam management and configure the respective access nodes 140, 142, in step 802. In step 804, the access node 104 of the serving cell and/or an access node 140, 142 of a non-serving cell may transfer the search space configurations. In step 802, the access node 104 may configure the CSS configuration while the access node 104 or the access node(s) 140, 142 may configure the second search space configuration to be used for the paging. As described above, the periodicity (the second time interval) of the second search space configuration may specific to the second search space configuration and be configured and signalled accordingly. Upon receiving the configurations, the terminal device may store them in blocks 200 and 202. As described above, step 802 may be carried out via RRC signalling. The second search space configuration may then be enabled for a non-serving cell via MAC signalling in step 806, for example. Accordingly, the terminal device may activate the second search space configuration with the respective second time interval for searching for the paging identifier (block 808). Thereafter, the terminal device may carry out the search in step 204 or 304, e.g. when a non-serving access node 140, 142 transmits the paging identifier of the terminal device.

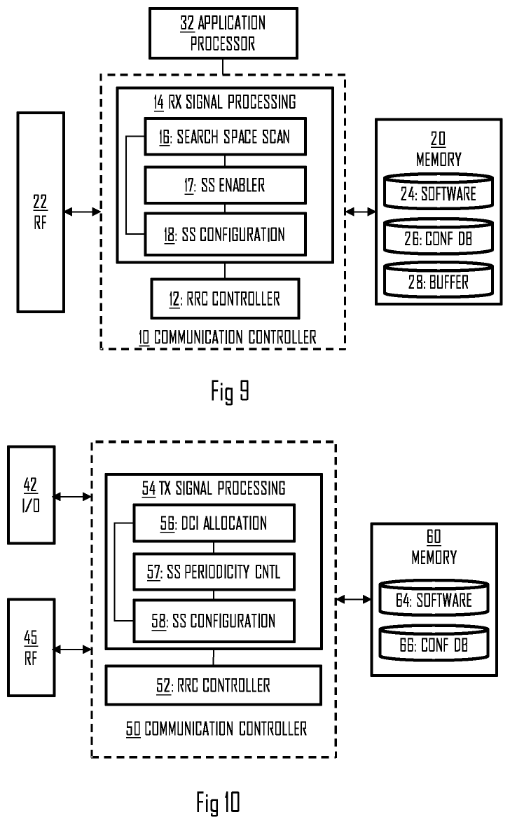

FIG. 9 illustrates an apparatus comprising means for carrying out the process of FIG. 2 or any one of the embodiments described above. The apparatus may comprise a processing circuitry, such as at least one processor, and at least one memory 20 including a computer program code (software) 24, wherein the at least one memory and the computer program code (software) are configured, with the at least one processor, to cause the apparatus to carry out the process of FIG. 2 or any one of its embodiments described above. The apparatus may be for the terminal device 100. The apparatus may be a circuitry or an electronic device realizing some embodiments of the invention in the terminal device. The apparatus carrying out the above-described functionalities may thus be comprised in such a device, e.g. the apparatus may comprise a circuitry such as a chip, a chipset, a processor, a micro controller, or a combination of such circuitries for the terminal device. The at least one processor or a processing circuitry may realize a communication controller 10 controlling communications in a radio interface of the cellular communication system in the above-described manner. The communication controller may be configured to establish and manage radio connections, transfer of data over the radio (RRC) connections and transmit the reference symbol sequences generated according to any one of the embodiments described herein.

The communication controller 10 may comprise a radio resource control (RRC) controller 12 configured to establish, manage, and terminate radio connections between the access node(s) of the cellular communication system and the terminal device. The RRC controller 12 may be configured, for example, to establish and reconfigure the RRC connections in the terminal device. The RRC controller may carry out steps 800 and 804 of FIG. 8 performed in the terminal device, for example, to configure the search space configurations.

The communication controller 10 may comprise a receiver signal processing circuitry 14 configured to perform the process of FIG. 2. The circuitry 14 may comprise a search space (SS) configuration circuitry 18 configured to carry out blocks 200 and 202. A search space enabler circuitry 17 may then enable at least some of the configured search space configurations according to a TCI active set received in step 806, for example. A search space scanning circuitry 16 may then scan the configured search spaces and search for the downlink control information addressed to the apparatus, e.g. carrying an identifier of the apparatus. Upon detecting the searched identifier and respective downlink control information, the circuitry 16 may output the downlink control information for further processing in the apparatus.

The apparatus may further comprise an application processor 32 executing one or more computer program applications that generate a need to transmit and/or receive data through the communication controller 30. The application processor may form an application layer of the apparatus. The application processor may execute computer programs forming the primary function of the apparatus. For example, if the apparatus is a sensor device, the application processor may execute one or more signal processing applications processing measurement data acquired from one or more sensor heads. If the apparatus is a computer system of a vehicle, the application processor may execute a media application and/or an autonomous driving and navigation application. The application processor may generate data to be transmitted in the wireless network and cause the need for executing the process of FIG. 2.

The memory 20 may be implemented using any suitable data storage technology, such as semiconductor-based memory devices, flash memory, magnetic memory devices and systems, optical memory devices and systems, fixed memory and removable memory. The memory 20 may comprise a configuration database 26 for storing configuration parameters, e.g. the search space configurations, the capabilities of the terminal device and the prioritization of the search space configurations, depending on the embodiment. The memory 20 may further store a buffer 28 for storing the signal(s) received within the search window(s).

The apparatus may further comprise a communication interface 22 comprising hardware and/or software for providing the apparatus with radio communication capability, as described above. The communication interface 22 may include, for example, an antenna, one or more radio frequency filters, a power amplifier, and one or more frequency converters. The communication interface 22 may comprise hardware and software needed for realizing the radio communications over the radio interface, e.g. according to specifications of an LTE or 5G radio interface.

FIG. 10 illustrates an apparatus comprising a processing circuitry, such as at least one processor, and at least one memory 60 including a computer program code (software) 64, wherein the at least one memory and the computer program code (software) are configured, with the at least one processor, to cause the apparatus to carry out functions of the access node 104, 140, or 142 in the process of FIG. 3 or any one of its embodiments described above. The apparatus may be for the access node. The apparatus may be a circuitry or an electronic device realizing some of the above-described embodiments in the access node. The apparatus carrying out the above-described functionalities may thus be comprised in such a device, e.g. the apparatus may comprise a circuitry such as a chip, a chipset, a processor, a micro controller, or a combination of such circuitries for the access node. In other embodiments, the apparatus is the access node. The at least one processor or a processing circuitry may realize a communication controller 50 controlling communications in the above-described manner. The communication controller may be configured to establish and manage radio connections and transfer of data over the radio connections.

The communication controller 50 may comprise an RRC controller 52 configured to establish, manage, and terminate radio connections with terminal devices served by the access node. The RRC controller 52 may be configured, for example, to establish and reconfigure the RRC connections with the terminal devices. The RRC controller may carry out steps 800 to 804 of FIG. 8, for example, to enable and configure the search space configurations for the terminal device. The communication controller may further comprise a scheduler (not shown) configured to schedule downlink/uplink transmission resources to the terminal devices. The communication controller may further call for the terminal device by adding an identifier of the terminal device into downlink control information addressed to the terminal device and transferred on the PDCCH in a search space configured to the terminal device. When the apparatus is for the non-serving access node 140, 142, the access node 140, 142 may still transmit at least the second search space configuration to the terminal device or at least transmit the paging identifier to the terminal device according to the second search space configuration, as described above.

The communication controller 50 may further comprise a transmission signal processing circuitry 54 configured to generate and transmit signals over the radio interface to the terminal device. The circuitry 54 may comprise a search space (SS) configuration circuitry 58 configured to carry out block 300 and 302 in the access node. A search space periodicity control circuitry 57 may then determine the second time interval for the second search space configuration, as described above in connection with block 302. A downlink control information (DCI) allocation circuitry 16 may then determine to transmit the DCI with the paging identifier of the terminal device, when the DCI allocation circuitry detects a need to page for the terminal device. The DCI allocation circuitry may then determine the search space configuration enabled currently for the terminal device for the paging. If the second search space configuration has been enabled, the DCI allocation circuitry may transmit the paging identifier and the respective DCI to the terminal device in time-frequency resources of the second search space configuration with the respective periodicity. Thereafter, the downlink control information on the control channel elements of the respective time-frequency resources may be transmitted to the terminal device over the radio interface.

The memory 60 may be implemented using any suitable data storage technology, such as semiconductor-based memory devices, flash memory, magnetic memory devices and systems, optical memory devices and systems, fixed memory and removable memory. The memory 60 may comprise a configuration database 66 for storing configuration parameters, e.g. the search space configurations for terminal devices served by the access node, the capabilities of the terminal devices etc.

The apparatus may further comprise a radio frequency communication interface 45 comprising hardware and/or software for providing the apparatus with radio communication capability with the terminal devices, as described above. The communication interface 45 may include, for example, an antenna array, one or more radio frequency filters, a power amplifier, and one or more frequency converters. The communication interface 45 may comprise hardware and software needed for realizing the radio communications over the radio interface, e.g. according to specifications of an LTE or 5G radio interface.

The apparatus may further comprise another communication interface 42 for communicating towards the core network. The communication interface may support respective communication protocols of the cellular communication system to enable communication with other access nodes, with other nodes of the radio access network, and with nodes in the core network and even beyond the core network. The communication interface 42 may comprise necessary hardware and software for such communications.

As used in this application, the term ‘circuitry’ refers to one or more of the following: (a) hardware-only circuit implementations such as implementations in only analog and/or digital circuitry; (b) combinations of circuits and software and/or firmware, such as (as applicable): (i) a combination of processor(s) or processor cores; or (ii) portions of processor(s)/software including digital signal processor(s), software, and at least one memory that work together to cause an apparatus to perform specific functions; and (c) circuits, such as a microprocessor(s) or a portion of a microprocessor(s), that require software or firmware for operation, even if the software or firmware is not physically present.

This definition of ‘circuitry’ applies to uses of this term in this application. As a further example, as used in this application, the term “circuitry” would also cover an implementation of merely a processor (or multiple processors) or portion of a processor, e.g. one core of a multi-core processor, and its (or their) accompanying software and/or firmware. The term “circuitry” would also cover, for example and if applicable to the particular element, a baseband integrated circuit, an application-specific integrated circuit (ASIC), and/or a field-programmable grid array (FPGA) circuit for the apparatus according to an embodiment of the invention.

The processes or methods described in FIG. 2, 3, or any of the embodiments thereof may also be carried out in the form of one or more computer processes defined by one or more computer programs. The computer program(s) may be in source code form, object code form, or in some intermediate form, and it may be stored in some sort of carrier, which may be any entity or device capable of carrying the program. Such carriers include transitory and/or non-transitory computer media, e.g. a record medium, computer memory, read-only memory, electrical carrier signal, telecommunications signal, and software distribution package. Depending on the processing power needed, the computer program may be executed in a single electronic digital processing unit or it may be distributed amongst a number of processing units.

Embodiments described herein are applicable to wireless networks defined above but also to other wireless networks. The protocols used, the specifications of the wireless networks and their network elements develop rapidly. Such development may require extra changes to the described embodiments. Therefore, all words and expressions should be interpreted broadly and they are intended to illustrate, not to restrict, the embodiment. It will be obvious to a person skilled in the art that, as technology advances, the inventive concept can be implemented in various ways. Embodiments are not limited to the examples described above but may vary within the scope of the claims.

1. An apparatus comprising:
at least one processor; and
at least one memory storing code that, when executed by the at least one processor, causes the apparatus at least to perform
receiving, for a control resource set, a first search space configuration for searching a downlink control channel carrying an identifier of the apparatus, wherein the first search space configuration defines a first time interval between consecutive periodic search windows;
receiving, for the control resource set, a second search space configuration for searching a downlink control channel carrying a paging identifier associated with the apparatus, wherein the second search space configuration defines a second time interval between consecutive periodic search windows;
enabling the second search space configuration upon receiving a message indicating a cell having a cell identifier different from a cell identifier of a cell serving the apparatus; and
searching for the identifier of the apparatus according to the first search space configuration and, in response to the enabling, searching for the paging identifier according to the second search space configuration.

2. The apparatus of claim 1, wherein the first search space configuration and the second search space configuration are both terminal-device-specific search space configurations unique to the apparatus.

3. The apparatus of claim 1, wherein the apparatus is further caused, in a case where the second search configuration has not been configured, to search for the paging identifier from a common search space of the cell serving the apparatus.

4. The apparatus of claim 1, wherein the second time interval is different from the first time interval.

5. The apparatus of claim 1, wherein the first search space configuration defines a common search space common to the apparatus and at least one other apparatus, and wherein the apparatus is further caused to prioritize the second search space configuration over the first search space configuration, if the first and the second search space configurations occur concurrently.

6. The apparatus of claim 1, wherein the apparatus is further caused to monitor for the paging identifier only according to the second search space configuration.

7. The apparatus of claim 1, wherein the first search space configuration defines a common search space common to the apparatus and at least one other apparatus, and wherein the first time interval is equal to the second time interval.

8. The apparatus of claim 1, wherein the apparatus is further caused to enable discontinuous reception between consecutive periodic search windows of the second search space configuration.

9. An apparatus comprising:
at least one processor; and
at least one memory storing code that, when executed by the at least one processor, causes the apparatus at least to perform
configuring, for a terminal device and for a control resource set, a first search space configuration for searching a downlink control channel carrying an identifier of the terminal device, wherein the first search space configuration defines a first time interval between consecutive periodic search windows;
configuring, for the terminal device and for the control resource set, a second search space configuration for searching a downlink control channel carrying a paging identifier associated with the terminal device, wherein the second search space configuration defines a second time interval between consecutive periodic search windows; and
causing transmission of the paging identifier to the terminal device according to the second search space configuration.

10. The apparatus of claim 9, wherein the apparatus is further caused to disable the second search space configuration, if the first search space configuration has been configured for paging.

11. The apparatus of claim 9, wherein the apparatus is further caused to enable the second search space configuration by transmitting to the terminal device a message indicating a cell having a cell identifier different from a cell identifier of a cell serving the terminal device.

12. A method comprising:
receiving, by a terminal device for a control resource set, a first search space configuration for searching a downlink control channel carrying an identifier of the apparatus, wherein the first search space configuration defines a first time interval between consecutive periodic search windows;
receiving, by the terminal device for the control resource set, a second search space configuration for searching a downlink control channel carrying a paging identifier associated with the terminal device, wherein the second search space configuration defines a second time interval between consecutive periodic search windows;
enabling, by the terminal device, the second search space configuration upon receiving a message indicating a cell having a cell identifier different from a cell identifier of a cell serving the terminal device; and
searching, by the terminal device, for the identifier of the terminal device according to the first search space configuration and, in response to the enabling, searching for the paging identifier according to the second search space configuration.

13. (canceled)

14. The apparatus of claim 1, wherein the at least one memory comprises a non-transitory computer-readable medium.

15. The apparatus of claim 9, wherein the at least one memory comprises a non-transitory computer-readable medium.
